(19) United States
(12) Patent Application Publication
(10) Pub. No.: US 2009/0072557 A1
(43) Pub. Date: Mar. 19, 2009

(54) Vehicle bumper system energy absorber

(75) Inventors: Steven Robert Roddy, Harrison Township, MI (US); Lawrence Landrith, Troy, MI (US); Randy D. Bigelow, Brighton, MI (US); James R. McFadden, Oxford, MI (US); Scott E. Cumberland, South Lyon, MI (US)

Correspondence Address: WARN, HOFFMANN, MILLER & LALONE, .P.C, PO BOX 70098, ROCHESTER HILLS, MI, 48307, US

(73) Assignee: Magna International Inc., Aurora (CA)

(21) Appl. No.: 11/901,580

(22) Filed: Sep. 18, 2007

(51) Int. Cl. B60R 19/03

(52) U.S. Cl. 293/120

(57) ABSTRACT

A bumper assembly providing an energy absorber, at least one connection support, at least one secondary component, and at least one insert. The energy absorber has at least one cavity that is defined by a plurality of walls. The connection support is integrated with the energy absorber, and is made of the same material as the energy absorber. The secondary component is integrated with the connection support. The at least one insert is in the cavity for altering the energy absorption characteristics of at least a portion of the energy absorber.

### FIELD OF THE INVENTION

The present invention relates to a vehicle bumper assembly. More particularly, the present invention relates to a bumper energy absorber assembly as part of the bumper system.

### BACKGROUND OF THE INVENTION

Most motorized vehicles typically have bumper assemblies which are used, among other things, for absorbing energy when a force is applied to the bumper assembly. Bumper assemblies can have many different types of designs based upon the desired energy absorption characteristics, the motorized vehicle model, or other desired design elements.

Brackets, adhesives, fasteners, or other components are typically used to connect the bumper assembly with other components for a desired design or energy absorbing feature. The connection process for connecting the different components of the bumper assembly can be a time consuming process and an expensive process due to the number of components needed and the space available on the assembly line. Further, the different parts can be made of different materials based upon certain factors, such as whether the component is an exterior component or a component that is covered and not visible.

Additionally, depending upon the design of the motorized vehicle or the federal regulations, the energy absorbing characteristics of the bumper assembly may have to be altered. Typically, to change the energy absorbing characteristics, the size and/or shape of an energy absorber in the bumper assembly must be re-designed. This can be a costly and timely process to re-design and re-test the bumper assembly to determine if the energy absorbing characteristics comply with the government and OEM regulations. For example, the depth of the energy absorber may have to be increased so that the energy absorber can absorb a greater amount of energy on impact.

Therefore, it is desirable to develop a bumper assembly with which the components are integrated with one another and made of the same material so that the energy absorbing characteristics can be altered or customized for particular applications.

### SUMMARY OF THE INVENTION

The present invention relates to a bumper assembly providing an energy absorber, at least one connection support, at least one secondary component, and at least one insert. The energy absorber has at least one cavity that is defined by a plurality of walls. The at least one connection support is integrated with the energy absorber, and is made of the same material as the energy absorber. The at least one secondary component is integrated with the at least one connection support. The at least one insert is in the cavity for altering the energy absorption characteristics of at least a portion of the energy absorber.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a front bumper assembly in accordance with an embodiment of the present invention;

FIG. 2 is a cross-sectional side view of a front bumper assembly along the line 2-2 of FIG. 1 in accordance with an embodiment of the present invention;

FIG. 3 is a perspective view of a rear bumper assembly in accordance with an embodiment of the present invention;

FIG. 4 is a cross-sectional view of a rear bumper assembly along the lines 4-4 of FIG. 3 in accordance with an embodiment of the present invention;

FIG. 5 is a plan view of an insert for an energy absorber using a snap-in connector in accordance with an embodiment of the present invention;

FIG. 6 is a plan view of an insert for an energy absorber using a snap-in connector in accordance with an embodiment of the present invention; and

FIG. 7 is a plan view of an insert for an energy absorber using a snap-in connector in accordance with an embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

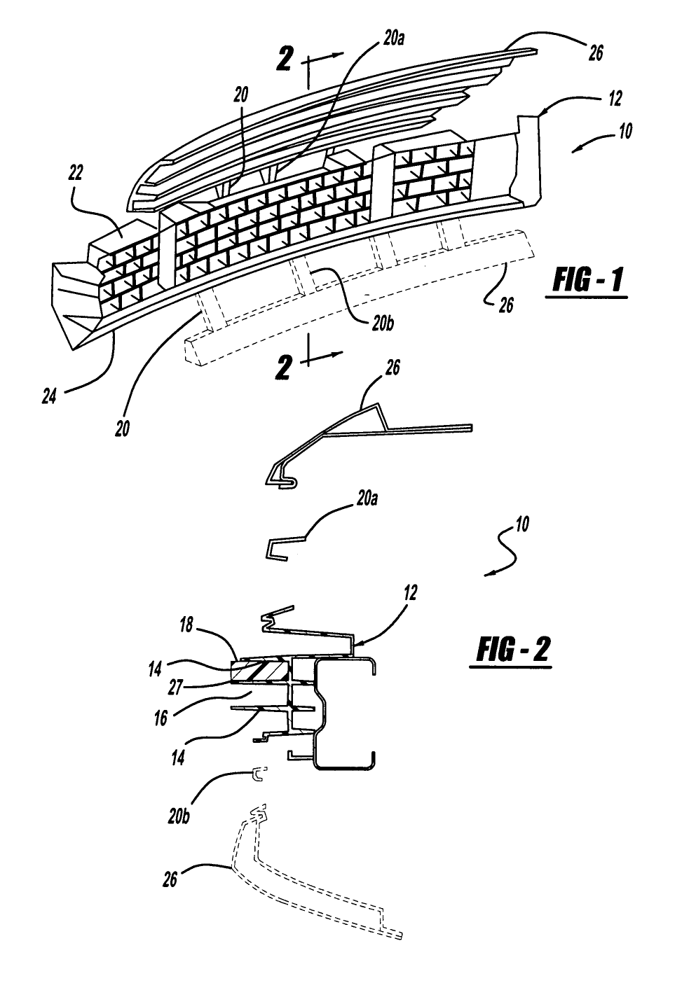

Referring to FIGS. 1-2 and 5-7, a front bumper assembly is generally shown at 10. The front bumper assembly 10 has an energy absorber generally indicated at 12. The energy absorber 12 has a plurality of walls 14 which define at least one cavity 16. At least one insert 18 is placed in at least one cavity 16 for altering the energy absorption crush characteristics of that portion of the energy absorber 12 while retaining uniform wall stock in the energy absorber for optimal molding cycle times. By way of explanation and not limitation, the cavity 16 and insert 18 are in 30 mm×60 mm sections in order to adequately alter the energy absorption characteristics of the bumper assembly 10 by removing or adding inserts 18, and the depth of the insert 18 is typically dependent upon other portions of the bumper assembly's 10 design.

As shown in FIGS. 1-2, at least one connection support 20 extends from the energy absorber 12. By way of explanation and not limitation, an upper connection support 20a is integrated with the energy absorber 12, such that the upper connections support 20a is made of the same material as the energy absorber 12. The upper connection support 20a can extend from a top 22 of the energy absorber 12. Further, a lower connection support 20b (shown in phantom) extends from a bottom 24 of the energy absorber 12. The lower connection support 20b can be integrated with the energy absorber 12, such that the lower connection support 20b is made of the same material as the energy absorber 12. The upper connection support 20a and lower connection support 20b are used for connecting at least one secondary component 26 to the energy absorber 12, as described in greater detail below. It should be appreciated that any combination of the upper connection support 20a and lower connection support 20b can be integrated with the energy absorber 12.

The secondary component 26 is integrated with the connection support 20, such that the secondary component 26 is made of the same material as the energy absorber 12 and the connection support 20. Thus, the secondary component 26 can be integrated with the upper connection support 20a, the lower connection support 20b, the like, or a combination thereof. Examples of the secondary component 26 are, but not limited to, a fascia valance panel, an air dam, a grill fog lamp pocket, fascia inserts grill attachments, or the like.

By way of explanation and not limitation, the energy absorber 12, connection support 20, and secondary component 26 are made of a thermal plastic polyolefin (TPO). The TPO can be energy absorbing, paint retaining, engrainable, have a Class A finish, the like, or a combination thereof. Therefore, the energy absorber 12, connection support 20, and secondary component 26 are integrated and made of the same material even though portions of the front bumper assembly 10 are non-exterior components while other portions of the front bumper assembly 10, such as the secondary component 26, are external components. This integration of parts allows for the front bumper assembly 10 to be multi-functional and requires less components, such as brackets or other fasteners, when compared to bumper assemblies which have separate components forming the energy absorber, the secondary components, and devices used to connect the two.

With respect to FIG. 2, the insert 18 is molded with the energy absorber 12, such that the insert 18 is attached to at least one wall 14 which defines the cavity 16. Thus, the insert 18 forms a living hinge 27 with the wall 14 with which it is connected. Therefore, the mold with which the energy absorber 12 is injection molded can be designed to mold the insert 18 for the desired cavities 16 based upon the predetermined energy absorption characteristics needed for the energy absorber 12.

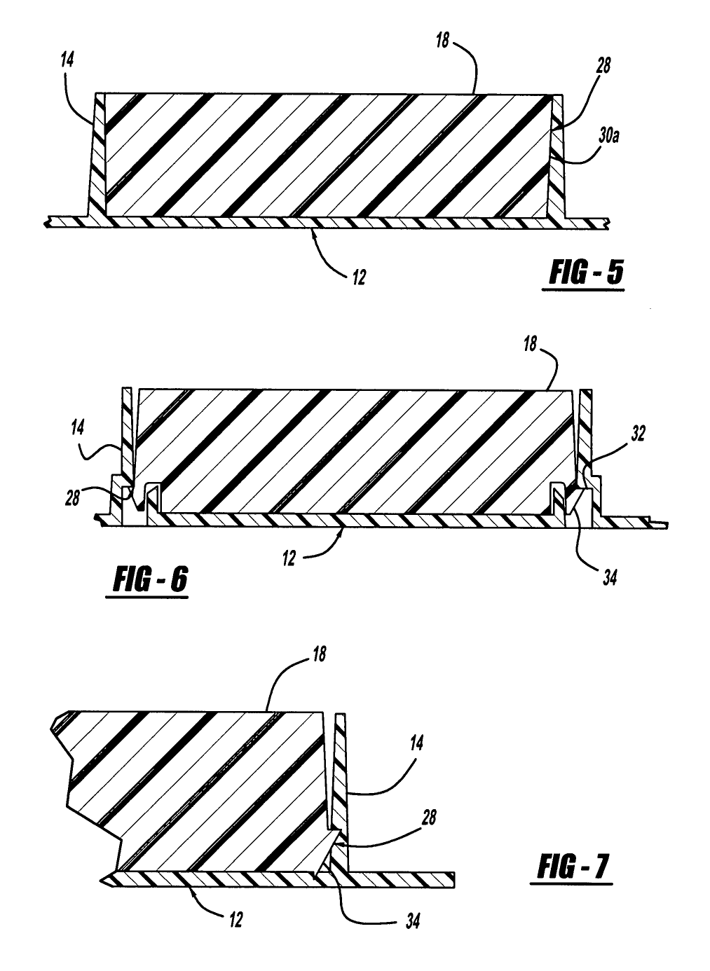

Referring to FIGS. 5-7, in an alternate embodiment the energy absorber 12 is injection molded without the inserts 18, but still has the walls 14 defining the cavity 16. The insert 18 is molded separately from the energy absorber 12 and attached to at least one of the walls 14 defining the cavity 16. The insert 18 can be attached to at least one wall 16 by a snap-in connector generally indicated at 28. Thus, one portion of the snap-in connector 28 is on the insert 18 while the adjoining portion of the snap-in connector 28 is on the wall 14 so that the insert 18 is connected to the wall 14. However, it should be appreciated that any other suitable form of attachment can be used, such as but not limited to, an adhesive, heat welding, sonic welding, or the like.

In reference to FIG. 5, the snap-in connector 28 is formed by the wall of the insert 18 being angled and the wall 14 having a corresponding angle, so that the insert 18 is inserted into the energy absorber 12 and the friction between the wall of the insert 18 and the wall 14 secures the insert 18. Alternatively, as shown in FIG. 6, the wall 14 can have an off-set which forms a lip 32. The insert 18 has a corresponding flange 34. When the insert 18 is inserted into the energy absorber 12, the flange 34 of the insert 18 is secured by the lip 32 so that the insert 18 is secured in the energy absorber 12. In an alternate embodiment shown in FIG. 7, the flange 34 contacts the wall 14 in order to secure the insert 18. By having the flange 34 forced into the wall 14, the friction between the flange 34 and wall 14 is adequate to secure the insert 18.

Further, the energy absorption characteristics of the bumper assembly 10 can be altered by changing the design of the insert 18. By way of explanation and not limitation, only a portion of an insert 18 can be inserted into the cavity 16 or the material used to form the insert 18 can be changed. The insert can also have various shapes and not necessarily be a solid block. For example the insert 18 can be formed to have a hollow cell with two or more sides that slide into the cavity so that a portion of the cavity 16 will remain hollow. FIG. 2 shows on alternate example of an insert having three sides that slide into the cavity 16.

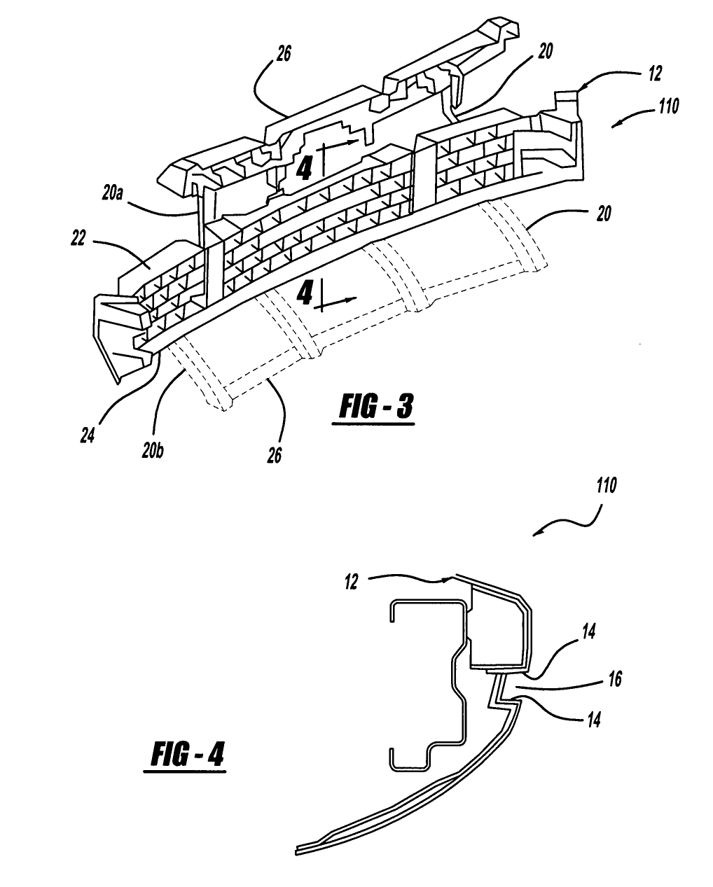

In reference to FIGS. 1-7, it should be appreciated that the above described front bumper assembly 10 (FIGS. 1 and 2) is similar to a rear bumper assembly generally shown at 110 (FIGS. 3 and 4) that can be used on a rear end of a motorized vehicle (not shown). Whether the front bumper assembly 10 or rear bumper assembly 110 is used in the front or rear end of the motorized vehicle, the components will remain the same as described above, but the design or shape of the above components can differ depending upon the vehicle model.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A bumper assembly comprising:
an energy absorber having at least one cavity defined by a plurality of walls of said energy absorber;
at least one connection support integrated with said energy absorber, wherein said at least one connection support is made of the same material as said energy absorber; and
at least one secondary component integrated with said at least one connection support.

2. The bumper assembly of claim 1, wherein an upper connection support of said at least one connection support extends from a top of said energy absorber.

3. The bumper assembly of claim 1, wherein a lower connection support of said at least one connection support extends from a bottom of said energy absorber.

4. The bumper assembly of claim 1, wherein said at least one secondary component is made of the same material as said energy absorber and said at least one connection support.

5. The bumper assembly of claim 1, wherein said secondary component is at least one of a fascia valence panel, an air dam, a grille fog lamp pocket, a fascia insert, and a grille attachment.

6. The bumper assembly of claim 1, wherein said energy absorber, said connection support, and said secondary component are made of a thermoplastic polyolefin selected to include at least one characteristic selected from the group of: energy absorbing; paint retaining; engrainable, and having a Class A finish.

7. The bumper assembly of claim 1, further comprising at least one insert in said at least one cavity for altering the energy absorption characteristics of at least a portion of said energy absorber wherein said at least one insert is molded with said energy absorber and attached to at least one of said plurality of walls defining said cavity forming a living hinge.

8. The bumper assembly of claim 7, wherein said insert is molded separately from said energy absorber and attached to at least one of said plurality of walls defining said cavity by a snap-in connector.

9. The bumper assembly of claim 8, wherein said snap-in connector includes a flange on said insert, and said flange contacts at least one said wall to secure said insert.

10. The bumper assembly comprising:
an energy absorber having a plurality of cavities defined by a plurality of walls of said energy absorber;
at least an upper connection support and lower connection support integrated with said energy absorber and made of the same material as said energy absorber;
at least one secondary component integrated to one of said upper connection support and lower connection support; and
at least one insert in at least one of said plurality of cavities for altering the energy absorption characteristics of at least a portion of said energy absorber.

11. The bumper assembly of claim 10, wherein said upper connection support extends from a top of said energy absorber.

12. The bumper assembly of claim 10, wherein a lower connection support extends from a bottom of said energy absorber.

13. The bumper assembly of claim 10, wherein said insert is molded with said energy absorber and attached to at least one said plurality of walls defining said cavity forming a living hinge.

14. The bumper assembly of claim 10, wherein said insert is molded separately from said energy absorber and attached to at least one said plurality of walls defining said cavity by a snap-in connector.

15. The bumper assembly of claim 14, wherein said snap-in connector includes a flange on said insert, and said flange contacts at least one said wall to secure said insert.

16. The bumper assembly of claim 10, wherein said secondary component is made of the same material as said energy absorber and said at least one connection support.

17. A bumper assembly comprising:
an energy absorber having a plurality of cavities defined by a plurality of walls of said energy absorber;
an upper connection support integrated with a top of said energy absorber, wherein said upper connection support is made of the same material as said energy absorber;
a lower connection support integrated with a bottom of said energy absorber, wherein said lower connection support is made of the same material as said energy absorber;
a secondary component integrated to at least one of said upper connection support and said lower connection support; and
at least one insert in at least one of said plurality of cavities for altering the energy absorption characteristics of at least a portion of said energy absorber.

18. The bumper assembly of claim 17, wherein said insert is molded with said energy absorber and attached to at least one said plurality of walls defining said cavity forming a living hinge.

19. The bumper assembly of claim 17, wherein said insert is molded separately from said energy absorber and attached to at least one said plurality of walls defining said cavity by a snap-in connector.

20. The bumper assembly of claim 19, wherein said snap-in connector includes a flange on said insert, and said flange contacts at least one said wall to secure said insert.
